(19) United States
(12) Patent Application Publication
(10) Pub. No.: US 2004/0003688 A1
(43) Pub. Date: Jan. 8, 2004

(54) Tool handle in particular of screwdriver, corresponding tool, and range of tools consisting of said tools

(76) Inventors: Catherine Gamba, Besancon (FR); Fabrice Brocard, Sellieres (FR)

Correspondence Address: WENDEROTH, LIND & PONACK, L.L.P., 2033 K STREET N. W., SUITE 800, WASHINGTON, DC, 20006-1021, US

(21) Appl. No.: 10/380,679

(22) PCT Filed: Sep. 17, 2001
(86) PCT No.: PCT/FR01/02885

(30) Foreign Application Priority Data
Sep. 20, 2000 (FR) 00/11986

(51) Int. Cl. B25G 1/01

(52) U.S. Cl. 81/489

(57) ABSTRACT

The tool handle comprises a core (2) adapted to be secured to the screwdriver blade (1), and a sleeve (3) of plastics material placed around the core, the core and the sleeve having portions in relief (9, 20) for mutual positioning in rotation, and mutual positioning means (5, 10, 11, 14, 17, 21, 22) for mutual positioning in axial translation. The sleeve (3) is a part that is distinct from the core, being made of a semi-rigid plastics material and being engaged on the core (2) from in front.

The present invention relates to a handle for a tool, in particular for a screwdriver, of the type described in the precharacterizing portion of claim 1.

This design makes it possible to implement a range of tools, in particular screwdrivers, at low cost and having different finishing layers, all starting from a single blank constituted by the core.

FR-A-2 730 658 proposes a screwdriver of the above-specified type in which the sleeve is overmolded onto the core fitted with the blade.

An object of the invention is to improve that tool so as to enable production throughput to be increased and also to increase reactivity, i.e. the ease with which the outer appearance of the tool can be modified, while simultaneously reducing manufacturing costs.

For this purpose, the invention provides a handle for a tool, in particular a screwdriver, of the above-specified type, characterized in that the sleeve is a part that is distinct from the core, being made of a semi-rigid plastics material and being engaged onto the core from in front.

The screwdriver handle of the invention may include one or more of the characteristics of claims 2 to 14.

The invention also provides a tool, in particular a screwdriver, having a handle as defined above and an extension, in particular a screwdriver blade, fixed in the handle.

The invention also provides a range of tools, in particular of screwdrivers, in which all of the tools in the range are as defined above and the handles of all of the tools of the range have the same core and differ in the outside shape and/or the color and/or a coating and/or marking of the sleeve.

Embodiments of the invention are described below with reference to the accompanying drawings, in which:

FIG. 1 is an elevation view of a screwdriver in accordance with the invention;

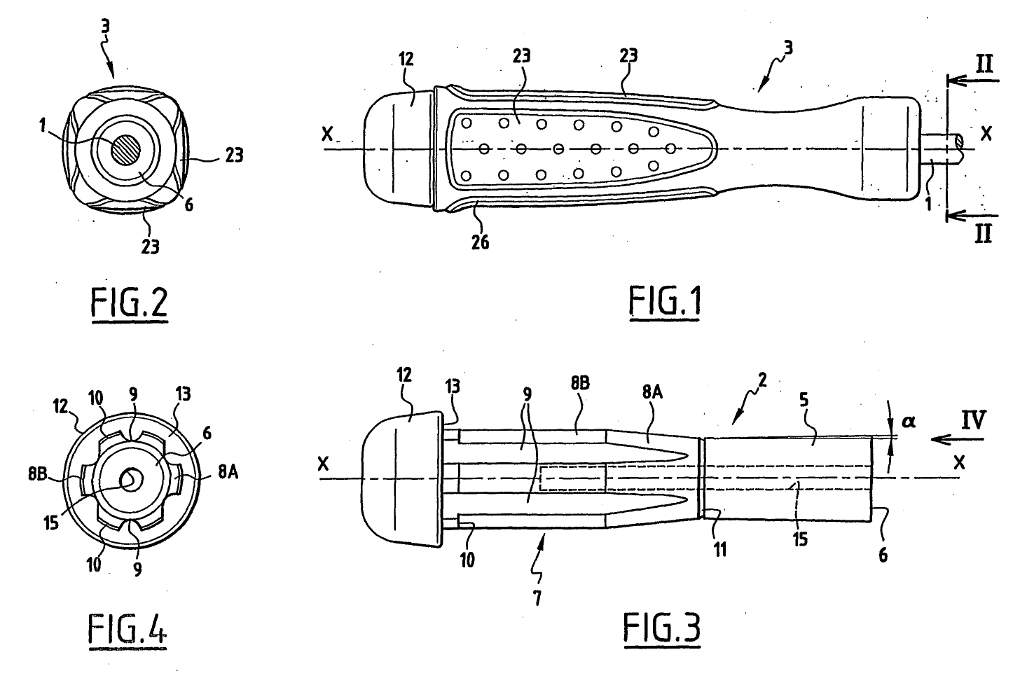

FIG. 2 is an end view from in front taken in section on line II-II of FIG. 1;

FIG. 3 is an elevation of the core of the FIG. 1 screwdriver;

FIG. 4 is an end view from in front of said core, seen looking along arrow IV in FIG. 3;

FIG. 5 is an elevation view of the FIG. 3 core after being turned through one-fourth of a turn about its own axis from the position of FIG. 3, together with an axial section view of the FIG. 1 screwdriver sleeve ready for engaging on the core;

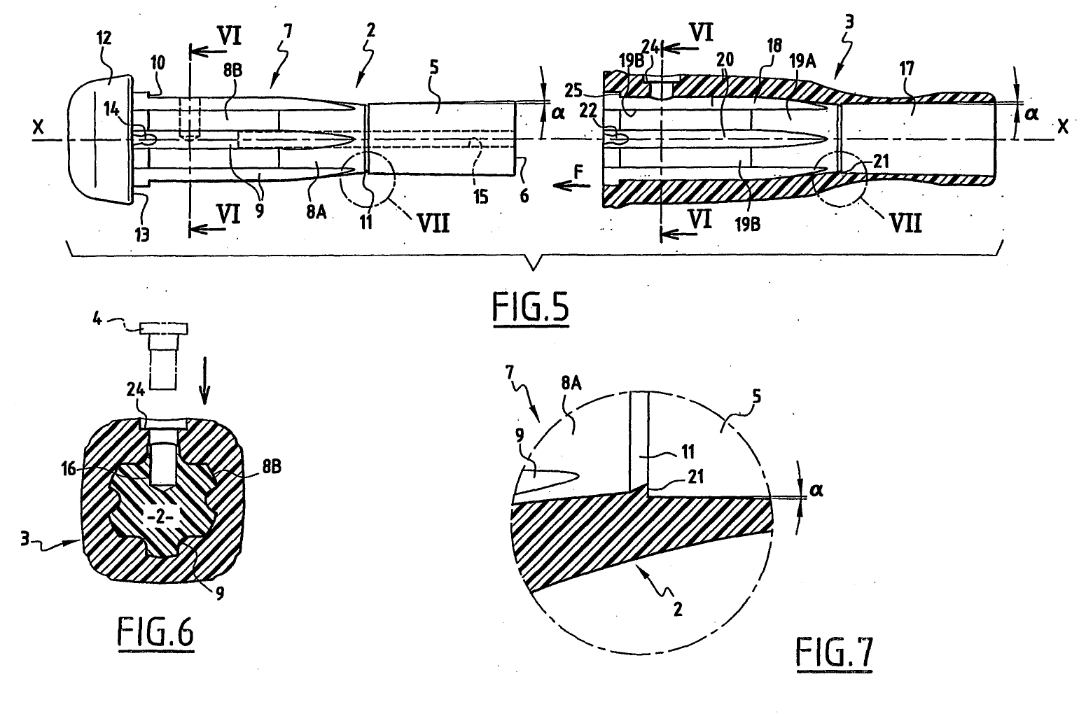

FIG. 6 is a cross-section of the assembled screwdriver, the section being on lines VI-VI of FIG. 5; and

FIG. 7 shows details VII of FIG. 5 on a larger scale, after the sleeve and the core have been assembled together.

The screwdriver shown in the drawings has a general axis X-X and is constituted by four parts: a metal blade 1, a core 2 of rigid plastics material, a sleeve 3 of semi-rigid plastics material, and a locking pin 4. These parts are made separately and then assembled together mechanically.

In the text below, the words “front” and “rear” relate respectively to the distal and proximal ends of the handle, and to the right and left ends as shown in FIGS. 1, 3, 5, and 7.

The core 2 is a solid body defining, going from front to rear:

a front portion 5 of small diameter that is substantially frustoconical, converging rearwards with a small angle at the apex α equal to about 0.2° to 1°, for example 0.5°, and whose front end face 6 is plane;

a fluted intermediate portion 7 comprising a forwardly-converging front region 8A followed by a cylindrical rear region 8B, and in which there are provided a plurality (six in this example) of longitudinally-extending cylindrical flutes 9. Close to its rear end, the region 8B has a radial shoulder 10 forming a step of slightly greater height. The portions 5 and 7 of the core are separated by a circular groove 11 having a radial front flank and a forwardly-converging rear flank; and

a rear knob 12 of roughly hemispherical shape, having a radial front face 13 joining the rear end of the region 8 and the fluting 9.

The core 2 also has a localized portion in relief 14 projecting from the bottom of one of the flutes 9. This portion in relief extends axially from the face 13 and presents a shape with an intermediate constriction when seen in plan view (FIG. 5). The core is also provided with an axial blind hole 5 which extends from its front end to an intermediate shoulder of the portion 7, and at the rear end of this hole 15 it has a radial blind hole 16 provided between two flutes 9 (FIGS. 5 and 6).

The inside shape of the sleeve (FIGS. 5 to 7) is complementary to the outside shape of the portions 5 and 7 of the core: a front portion 17 converging rearwardly at the angle α, and a rear portion 18 having a rearwardly-diverging front region 19A followed by a cylindrical rear region 19B with six axial splines 20 projecting from its cylindrical inside surface. The portions 17 and 18 are separated by a circular rib 21 whose front flank is radial while its rear flank converges forwards (FIG. 7).

At the rear end of one of the splines 20 there is provided an indentation 22 that is complementary to the portion in relief 14 on the core, and that is open rearwardly.

On the outside, the sleeve has a section which is circular in its portion 17 and which is roughly polygonal (square in this example) in its portion 18. Its profile lengthwise (FIG. 5) on going from front to rear convex, then concave, and then substantially parallel to the axis X-X. Each face of the portion 18 has portions in relief 23 with rounded edges formed thereon (FIG. 1) for improving grip on the tool.

A stepped radial orifice 24 is formed through the sleeve between two splines 20, and a hollow radial shoulder 23 is provided at the rear end of the cylindrical surface 19B.

The core 2 and the sleeve 3 are made separately by injection molding, the sleeve is engaged on the core by being threaded on from in front (arrow F in FIG. 5), with its indentation 22 in the same radial half-plane as the portion in relief 14. The splines 20 penetrate into the fluting 9 until the shoulders 10 of the core come into abutment against the complementary shoulders 25 of the sleeve. At the end of this movement, the portion in relief 14 snaps into the indentation 22 and the rib 21 snaps into the groove 11. The front end of the sleeve is then substantially in register with the end face 6 of the core, leaving the end face visible.

The sleeve is then prevented from turning relative to the core by the splines 20 and the fluting 9, and it is locked in translation, rearwards by the shoulders 10, and forwards by three means: firstly by co-operation between the rib 21 and the groove 11; secondly by the undercut surfaces 5 and 17; and finally by the portion in relief 14 snap-fastening in the indentation 22.

To supplement and to reinforce this locking, the pin 4 is forced through the orifice 24 and into the hole 16 in the core (FIG. 6).

The assembly operations, including force-fitting the rear portion of the blade 1 in the axial hole 15 of the core, can be performed automatically. The same applies to marking the sleeve which is easy to take hold of and to manipulate because it is semi-rigid.

The term “semi-rigid” is used to mean that it has the property of being substantially undeformable, while nevertheless being sufficiently elastic to deform slightly under the action of high forces of the kind developed in a press. This is in contrast both to the almost completely rigid core material, and to the flexibility of elastomers.

By way of example, the core can be made of polypropylene or of cellulose acetate, while the sleeve can be made of soft polypropylene which is a material sold under the trade name “Santoprene”.

Depending on the application, recourse may be had to any appropriate combination of the four axial locking means described above (5-17, 11-21, 14-22, and 4-16-23). The first three locking means are completely hidden by the sleeve, while the pin 4 is visible in its orifice 24 and can then be used for color coding.

In a variant, the sleeve may be made as a composite part having part or all of its outside surface covered in a more flexible surface layer for gripping purposes, as referenced 26 in FIGS. 5 and 7.

In another variant, the core 2 may be overmolded on the blade 1.

1/ A handle for a tool, in particular a screwdriver, the handle being of the type comprising a core (2) adapted to be secured to the blade (1) of the screwdriver, and a sleeve (3) of plastics material placed around the core, the core and the sleeve having portions in relief (9, 20) for mutual positioning in rotation, and mutual positioning means (4, 5, 10, 11, 14, 16, 17, 21, 22, 24, 25) for mutual positioning in axial translation, the handle being characterized in that the sleeve (3) is a part that is distinct from the core, being made of a semi-rigid plastics material and being engaged onto the core (2) from in front.

2/ A handle according to claim 1, characterized in that the sleeve extends to the front end of the handle.

3/ A handle according to claim 1 or claim 2, characterized in that the mutual positioning means (4, 5, 10, 11, 14, 17, 21, 22, 24, 25) comprise rear abutment means (10, 25) and locking means (5-17, 11-21, 14-22, 4-16-24) for locking the sleeve in its rear abutment position.

4/ A handle according to claim 3, characterized in that the locking means (5-17, 11-21, 14-22) comprise cooperating portions in relief on the core (2) and on the sleeve (3), said portions in relief being hidden by the sleeve.

5/ A handle according to claim 4, characterized in that the core (2) and the sleeve include complementary surfaces (5-17) extending from their front end faces (6) and converging rearwards to constitute means for locking the sleeve in its rear abutment position.

6/ A handle according to claim 5, characterized in that the angle of convergence (α) of said complementary surfaces (5-17) is about 0.2° to 1°, and in particular about 0.5°.

7/ A handle according to any one of claims 4 to 6, characterized in that the locking means comprise at least one male portion in relief (14-21) of the core (2) or of the sleeve (3) snap-fastening axially in a recess (11, 22) in the other one of said two elements.

8/ A handle according to clam 7, characterized in that said portion in relief (21) is a circular rib and said recess (11) is a circular groove.

9/ A handle according to claim 8, characterized in that both the rib (21) and the groove (11) have a respective front flank that its radial and a respective rear flank that converges forwardly.

10/ A handle according to any one of claims 7 to 9, characterized in that said portion in relief (21) is provided in the sleeve (3) and said recess (11) is provided in the core (2).

11/ A handle according to claims 5 and 10 taken together, characterized in that said portion in relief (21) is provided at the rear end of the converging surface (17) of the sleeve (3).

12/ A handle according to claim 7, characterized in that said portion in relief (14) is a localized projection on the rear portion of the core (2) adapted to snap axially into a rearwardly-open localized recess (22) provided at the rear end of the sleeve (3).

13/ A handle according to claim 3, characterized in that the locking means comprise a locking pin (4) which passes through a radial orifice (24) of the sleeve (3) and penetrates in a radial recess (16) of the core (2).

14/ A handle according to any one of claims 1 to 13, characterized in that the sleeve (3) carries a grip layer (26) on at least a portion of its outside surface, said grip layer being made of a relatively flexible material.

15/ A tool, in particular a screwdriver, of the type comprising a handle and an extension (1), in particular a screwdriver blade (1) fixed to said handle, the tool being characterized in that the handle is in accordance with any one of claims 1 to 14.

16/ A range of tools, in particular of screwdrivers, characterized in that all of the tools of the range are in accordance with claim 15 and in that the handles (3) of all of the tools of the range have the same core (2) and differ in the outside shape and/or the color and/or a coating and/or marking on the sleeve (3).
